(19) United States
(12) Patent Application Publication
(10) Pub. No.: US 2024/0370755 A1
(43) Pub. Date: Nov. 7, 2024

(54) PARAMETRICALLY DRIVEN TWO-QUBIT QUANTUM GATES WITH CONTROLLABLE ZZ-INTERACTION

(71) Applicant: Google LLC, Mountain View, CA (US)

(72) Inventors: Julian Shaw Kelly, Santa Barbara, CA (US); Charles Neill, Goleta, CA (US)

(21) Appl. No.: 18/312,384

(22) Filed: May 4, 2023

(51) Int. Cl. G06N 10/40; G06N 10/20

(52) U.S. Cl. CPC G06N 10/40; G06N 10/20

(57) ABSTRACT

Methods, systems and apparatus for implementing a two-qubit quantum gate on a quantum system including a first qubit and a second qubit interacting via a coupler. In one aspect, a method includes: evolving a state of the quantum system for a predefined period of time under a Hamiltonian describing the quantum system; and performing a pulse schedule on the quantum system during evolution of its state. The pulse schedule includes: driving the quantum system with one or more baseband pulses; and driving the coupler with a parametric pulse having a center frequency greater than an average qubit anharmonicity of the first and second qubits.

### BACKGROUND

This specification relates to quantum computing.

Classical computers have memories made up of bits, where each bit can represent either a zero or a one. Quantum computers maintain sequences of quantum bits, called qubits, where each quantum bit can represent a zero, one, or any quantum superposition of zeros and ones. Quantum computers operate by setting qubits in an initial state and controlling the qubits, e.g., according to a sequence of quantum logic gates.

### SUMMARY

This specification describes pulse schedule strategies for implementing parametrically driven two-qubit quantum gates with controllable swap angle and conditional phase. Such two-qubit quantum gates can include imaginary swap (iSWAP) gates, controlled-Z (CZ) gates, and other quantum gates belonging to the Fermionic simulation (fSim) gate set. The iSWAP and CZ gates can be utilized for quantum error correction using the surface code, which can facilitate fault-tolerant quantum computing and implementation of fundamental quantum processing algorithms such as Shor's algorithm.

According to a first aspect, there is provided a method for implementing a two-qubit quantum gate on a quantum system including a first qubit and a second qubit interacting via a coupler. The method includes: evolving a state of the quantum system for a predefined period of time under a Hamiltonian describing the quantum system; and performing a pulse schedule on the quantum system during evolution of its state. The pulse schedule includes: driving the quantum system with one or more baseband pulses; and driving the coupler with a parametric pulse having a center frequency greater than an average qubit anharmonicity of the first and second qubits.

In some implementations, the one or more baseband pulses have bandwidths less than the average qubit anharmonicity of the first and second qubits.

In some implementations, the one or more baseband pulses are rectangular pulses.

In some implementations, the one or more rectangular pulses have pulse widths equal to the predefined period of time.

In some implementations, the parametric pulse is a sinusoidal wave oscillating at the center frequency.

In some implementations, driving the quantum system with the one or more baseband pulses includes driving at least one of the first or second qubits with a first baseband pulse to bring a first state of the first and second qubits on resonance with a second state of the first and second qubits.

In some implementations, the first and second states are computational states.

In some implementations, the first state is a computational state and the second state is a non-computational state.

In some implementations, driving the quantum system with the one or more baseband pulses further includes driving the coupler with a second baseband pulse to cycle between the first and second states.

In some implementations, the second baseband pulse is amplitude modulated by the parametric pulse.

In some implementations, the two-qubit quantum gate is a Fermionic simulation (fSim) gate.

In some implementations, the fSim gate is an iSWAP gate or a CZ gate.

In some implementations, the Hamiltonian (H) describing the quantum system is represented, at least approximately, by:

$$\hat{H} ( t ) = {\sum }_{i = 1}^{2} [ {ω}_{i} ( t ) {\hat{n}}_{i} + \frac{{η}_{i}}{2} {\hat{n}}_{i} ( {\hat{n}}_{i} - 1 ) ] + g ( t ) ( {\hat{a}}_{1} {\hat{a}}_{2}^{†} + {\hat{a}}_{1}^{†} {\hat{a}}_{2} ) ,$$

where \hat{n}ᵢ=âᵢ^{†}âᵢ is a respective excitation number operator of the first or second qubit, âᵢ^{†} and âᵢ are respective creation and annihilation operators of the first or second qubit, ωᵢ(t) is a respective qubit frequency of the first or second qubit, ηᵢ is a respective qubit anharmonicity of the first or second qubit, and g(t) is a two-qubit coupling strength of the coupler describing the interaction between the first and second qubits.

In some implementations, the first and second qubits are superconducting qubits.

In some implementations, the first and second superconducting qubits are transmon qubits.

In some implementations, the average qubit anharmonicity is in a range from 200 megahertz (MHz) to 300 MHz.

In some implementations, the center frequency is in a range from 250 MHz to 500 MHz.

In some implementations, the predefined period of time is 50 nanoseconds (ns) or less.

According to a second aspect, there is provided an apparatus including: a quantum system including a first qubit and a second qubit interacting via a coupler; and a control system including: one or more control devices; and one or more control lines coupled to the one or more control devices and the quantum system. The control system is configured to: evolve a state of the quantum system for a predefined period of time under a Hamiltonian describing the quantum system; and perform a pulse schedule on the quantum system during evolution of its state. The pulse schedule includes: driving the quantum system with one or more baseband pulses; and driving the coupler with a parametric pulse having a center frequency greater than an average qubit anharmonicity of the first and second qubits.

In some implementations, the first and second qubits are superconducting qubits.

Particular embodiments of the subject matter described in this specification can be implemented so as to realize one or more of the following advantages.

Quantum algorithms involving quantum superposition and quantum entanglement of qubits can offer speedups for computational problems in material science, physics, chemistry, and other classical and non-classical computational problems. However, near-term realizations of these algorithms involve implementation within existing noisy hardware. Taking advantage of the adjustable coupling of qubits in certain quantum computing architectures, the systems and methods described herein can implement a continuous two-qubit quantum gate set, e.g., the Fermionic simulation (fSim) gate set, that can provide a threefold reduction in circuit depth as compared to a standard decomposition. For example, the systems and methods disclosed herein can use pulse schedules including baseband and parametric pulses to implement an iSWAP gate in superconducting architectures (e.g., using transmon qubits) with low leakage and high fidelity. Such a gate has typically been unachievable in currently available superconducting quantum computing hardware due to the ZZ-interaction. The systems and methods disclosed herein provide a means of controlling the ZZ-interaction and the associated conditional (ZZ) phase to realize the iSWAP gate, which may be utilized for the error correcting surface code and implementation of various quantum algorithms that rely on such error correction, e.g., Shor's algorithm.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a schematic diagram of an example quantum computer.

FIG. 2A shows a schematic diagram of an example quantum circuit that can execute a quantum algorithm.

FIG. 2B shows a schematic diagram of implementing an example two-qubit quantum gate on a quantum subsystem using a pulse schedule.

FIG. 3 shows plots of an example pulse schedule, swap probability, leakage probability, and conditional phase of an iSWAP-like gate as functions of time.

FIG. 4 shows plots of conditional phase and leakage probability of an example iSWAP-like gate as functions of parametric driving frequency.

FIG. 5 shows plots of an example pulse schedule, swap probability, leakage probability, and conditional phase of an iSWAP gate as functions of time.

FIG. 6A is a flow chart of an example process for implementing a two-qubit quantum gate on a quantum system using a pulse schedule.

FIG. 6B is a flow chart of an example process for implementing a pulse schedule.

FIG. 7 shows plots of conditional phase, swap probability, and leakage probability of an iSWAP-like gate as functions of parametric driving amplitude and frequency.

Like reference numbers and designations in the various drawings indicate like elements.

### DETAILED DESCRIPTION

Quantum algorithms can be represented by quantum circuits that include a set of universal instructions, e.g., universal quantum gates. An example of a universal gate set includes the Hadamard gate, S gate, T gate, and the two-qubit entangling controlled-not (CNOT) gate. Another example universal gate set includes a single three-qubit Fredkin gate and the Hadamard gate. Yet another example universal gate set includes representations of the Fermionic simulation (fSim) gate set. The fSim gate set contains excitation-conserving (e.g., photon-conserving) two-qubit quantum gates. Consequently, an fSim quantum gate can be defined with two control angles; the |01 [symbol] ↔|10 [symbol] swap angle θ, and the |11 [symbol] conditional (ZZ) phase ϕ. An fSim quantum gate has a matrix representation in the |00 [symbol] , |01 [symbol] , |10 [symbol] , and |01 [symbol] state basis given by:

$$fSim ( θ , ϕ ) = [ \begin{matrix}1 & 0 & 0 & 0 \\ 0 & cos θ & - i sin θ & 0 \\ 0 & - i sin θ & cos θ & 0 \\ 0 & 0 & 0 & {e}^{- i ϕ}\end{matrix} ] . \qquad ( 1 )$$

For example, the matrix in Eq. (1) can describe two-qubit quantum gates resulting from arbitrary flux control (e.g., a pulse schedule) of two coupled superconducting qubits. Further discussion on the fSim gate set implemented with superconducting qubits is provided by Foxen, Brooks, et al. “Demonstrating a continuous set of two-qubit gates for near-term quantum algorithms.” Physical Review Letters 125.12 (2020): 120504.

For the near-term application of quantum computers, one major focus is to minimize the experimental resources necessary for building a useful quantum circuit from elementary quantum gates. One of the main objectives of these quantum circuits is implementing quantum algorithms with error correction. This specification provides systems and methods for implementing two-qubit quantum gates from the fSim gate set with high fidelity using pulse schedules applied to qubit frequency detunings and two-qubit coupling strengths. The iSWAP and CZ gates are specific cases of the fSim gate set corresponding to

$$iSWAP = sSim ( \frac{π}{2} , 0 ) and CZ = fSim ( 0 , π ) ,$$

respectively. These gates have received considerable attention due to their ability to implement the error correcting surface code. Particularly, the iSWAP gate has been highly sought after in superconducting quantum computer architectures due to their efficiency in performing the |01 [symbol] ↔|10 [symbol] swap. However, an iSWAP gate has not been realizable on currently available quantum hardware (e.g., the “Sycamore” quantum processor) due to the inherent ZZ-interaction which adds a non-negligible conditional (ZZ) phase ϕ≠0 to the iSWAP gate. This specification provides systems and methods for realizing an iSWAP gate by controlling the ZZ-interaction and the resulting ZZ phase using pulse schedules including both baseband and parametric pulses. Such systems and methods can be implemented on currently available quantum hardware and can also be adapted for new quantum hardware to facilitate improved quantum gate control.

These features and other features are described in more detail below.

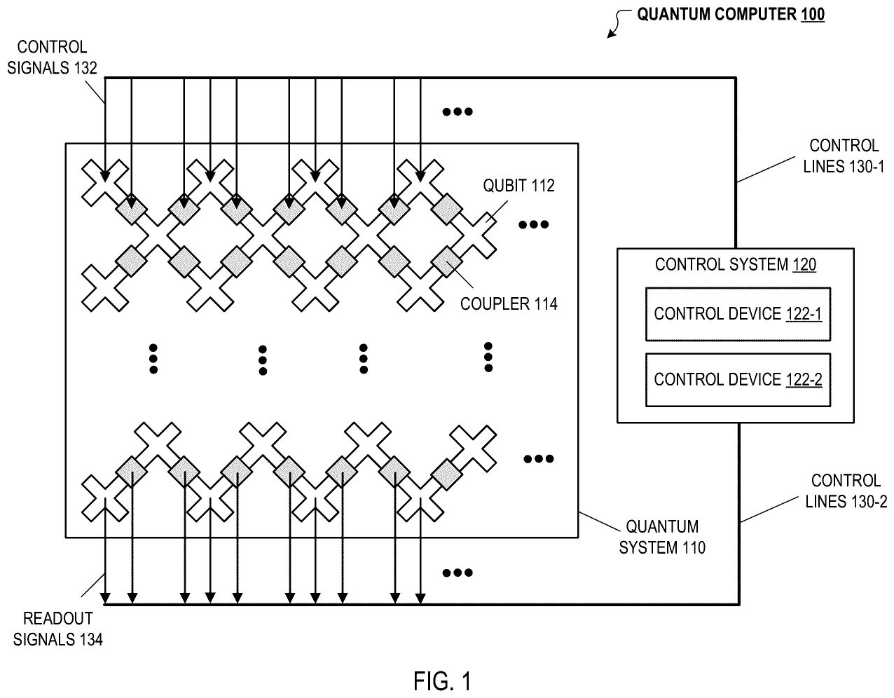

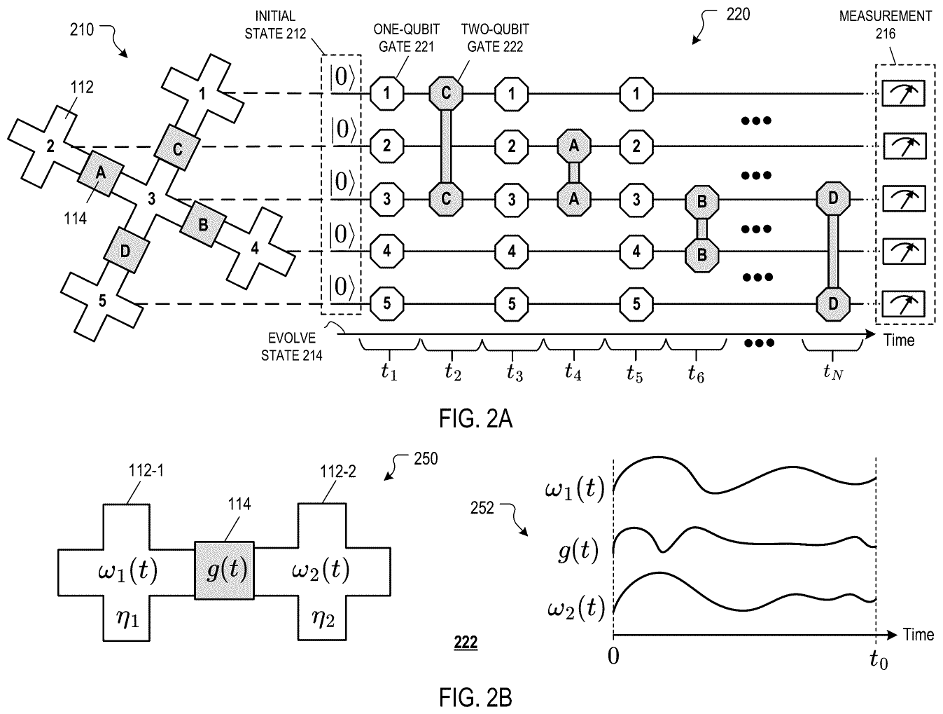

FIG. 1 shows a schematic diagram of an example quantum computer 100. The quantum computer 100 includes a quantum system 110, e.g., quantum hardware, a quantum processor, a quantum chip, a qubit assembly, etc. The quantum computer 100 also includes a (classical) control system 120 coupled to the quantum system 110 via one or more control lines 130. By controlling the quantum system 110 with the control system 120, the quantum computer 100 can implement quantum circuits (see FIG. 2A for example) that can execute quantum processing algorithms. Such quantum algorithms may include, but are not limited to: Shor's algorithm, Grover's algorithm, the Deutsch-Jozsa algorithm, Simon's algorithm, the quantum phase estimation (QPE) algorithm, among others. For example, using the pulse schedule strategies disclosed herein, the quantum computer 100 may be capable of performing surface code error correction using iSWAP or CZ gates that may realize Shor's algorithm.

For superconducting quantum computer 100 architectures, an iSWAP-like gate is generally less demanding in terms of frequency arrangement and may be performed at a higher fidelity than the CZ gate. Moreover, it has recently been shown by McEwen, Matt, Dave Bacon, and Craig Gidney, “Relaxing Hardware Requirements for Surface Code Circuits using Time-dynamics,” arXiv preprint arXiv:2302.02192 (2023), that efficient surface code circuits can be constructed with three qubit couplings per qubit rather than four, using iSWAP gates instead of CZ gates. This specification provides a means of realizing an iSWAP gate in superconducting quantum computers (and other architectures) with high fidelity and may meet the threshold for fault-tolerant quantum computing.

The quantum computer 100 may also be utilized for quantum supremacy experiments that use a two-dimensional qubit array, e.g., quantum supremacy experiments that aim to entangle every pair of qubits in the qubit array using a circuit depth such that no classical computer can conveniently calculate the amplitude of each computational basis without requiring an exponential number of qubit computational steps. An example of such an experiment is provided by Frank Arute, et al. “Quantum supremacy using a programmable superconducting processor,” Nature 574.7779 (2019): 505-510, which utilized the “Sycamore” quantum processor to demonstrate the advantage of quantum hardware over classical hardware for a particular computational problem.

In the implementation shown in FIG. 1, the quantum system 110 includes a rectangular array of qubits 112 and couplers 114. Such a qubit-coupler quantum system 110 can be realized in many different fields of quantum computing using different types of qubits 112 and couplers 114. In general, the quantum computer 100 can be any suitable quantum architecture capable of entangling qubits 112 with sufficiently long coherence times, e.g., about 10 microseconds (μs) or more, about 20 μs or more, about 30 μs or more, about 40 μs or more, about 50 μs or more, about 100 μs or more, about 250 μs or more. For example, the quantum computer 100 can be a superconducting quantum computer 100 and the qubits 112 can be superconducting qubits, e.g., charge qubits, phase qubits, or flux qubits. The superconducting qubits can also be hybridizations of these qubit archetypes, e.g., transmons, xmons, or gatemons. Superconducting qubits, particularly transmon qubits, are a promising candidate for near-term quantum computing as they have a high degree of controllability, a relatively high entanglement depth, and have experimentally demonstrated coherence times reaching over 500 μs. As another example, in an atomic quantum computer 100, the qubits 112 can be hyperfine atomic qubits, e.g., trapped ions. Trapped ions have achieved coherence times of over 50 secs experimentally but may be more prone to leakage (i.e., have lower fidelity quantum gates) compared to other qubits due to the many available hyperfine sublevels in such systems. In a nuclear magnetic resonance (NMR) quantum computer 100, the qubits 112 can be nuclear spin qubits. Nuclear spin qubits have achieved coherence times of over 500 milliseconds (ms) experimentally but may lack the qubit entanglement depth achievable by other qubits due to relatively weak and/or short-range spin-spin interactions. Quantum computer 100 can also implement other types of qubits 112 such as electron spin qubits and vibrational qubits. The systems and methods disclosed herein are suitable for any of the abovementioned quantum computer 100 architectures and can mitigate one or more of the tradeoffs between such architectures. Note, while the qubits 112 and couplers 114 are depicted in FIG. 1 as arranged in a two-dimensional rectangular array, this is a schematic depiction and is not intended to be limited to this particular qubit-coupler arrangement. For example, three-dimensional and one-dimensional arrays (e.g., one-dimensional arrays of trapped ions or nuclear spins) are also feasible.

Each qubit 112 interacts with a nearest neighboring qubit 112 via a coupler 114. That is, each coupler 114 mediates the interaction strength between two nearest-neighbor qubits. The type of coupler 114 implemented by the quantum system 110 is generally dependent on its particular quantum architecture. For example, in cases where the qubits 112 are superconducting qubits, the coupler 114 may include a capacitor, an inductor, or a combination of a capacitor and an inductor. Inductive and capacitive couplers 114 can be achieved through intermediate nonlinear Josephson junctions. As another example, in cases where the qubits 112 are hyperfine atomic qubits, the coupler 114 may include components that mediate light-matter interactions such as an optical waveguide, an optical resonator, an optical cavity, a photonic crystal, and/or other circuit quantum electrodynamics (QED) components. As yet another example, in cases where the qubits 112 are nuclear spin qubits, the coupler 114 may include components that mediate spin-spin interactions such as a microwave waveguide, a microwave resonator, a microwave cavity, a photonic metamaterial, and/or other microwave circuit QED components. As mentioned above, the qubits 112 and couplers 114 are arranged in a rectangular array such that each qubit 112 (that is not located at an edge of the quantum system 110) interacts with four of its nearest neighbors via four respective couplers 114. However, other arrangements of qubits 112 and couplers 114 are also possible, e.g., where each qubit interacts with less than four adjacent qubits or more than four adjacent qubits via respective couplers. Such arrangements can include repetitive patterns of qubits and couplers, e.g., patterns belonging to the wallpaper group, but may also include non-repetitive patterns in some instances. Such arrangements can also allow for coupling between non-adjacent qubits 112, e.g., next-nearest neighbors, next-next-nearest neighbors, next-next-next-nearest neighbors, and so on. Such arrangements can also include couplers 114 mediating interactions between more than two qubits 112, e.g., three, four, five, six, seven, eight, or more qubits.

In general, a quantum processing algorithm proceeds by control system 120 initializing the qubits 112 in a selected initial state (e.g., the ground state) and then applying a sequence of quantum gate operations to the qubits 112, which can include one-qubit gate operations such as X, Y, Z, or Hadamard gates; two-qubit gate operations such as CX, CZ, and iSWAP gates; and gate operations involving three or more qubits such as Toffoli gates. An example of a quantum algorithm being realized by an example quantum circuit is shown in FIG. 2A. Control system 120 can carry out gate operations by applying various control signals 132 (e.g., pulse schedules) to the qubits 112 and the couplers 114; these might include, for example, radiofrequency (RF) or microwave pulses in an NMR or superconducting quantum computer 100, or optical pulses in an atomic quantum computer 100. At the conclusion of the quantum processing algorithm, control system 120 measures the final states of the qubits 112 using a quantum observable such as Z, with readout signals 134 that, again, might be RF, microwave, or optical signals depending on the quantum architecture of the quantum computer 100. For illustrative purposes in FIG. 1, the control signals 132 and readout signals 134 are depicted as addressing only selected elements of the quantum system 110 (i.e., the top and bottom rows respectively), but these control 132 and readout 134 signals can address every element in the quantum system 110.

The control system 120 can include one or more classical (i.e., non-quantum) control devices 122, e.g., control devices 122-1 and 122-2. The control system 120 can be programmed to send a selected sequence of control signals 132 to the quantum system 110 (e.g., to carry out a selected series of quantum gate operations) via control lines 130-1, and to receive a sequence of readout signals 134 from the quantum system 110 (e.g., to carry out a selected series of measurements) via control lines 130-2. Thus, for example, the one or more control devices 122 can include digital-to-analog converters (DACs), analog-to-digital converters (ADC), linear controllers (e.g., proportional-integral-derivative (PID) controllers), nonlinear controllers, and RF/microwave/optical signal generators, transmitters, receivers, and transceivers, as appropriate for the quantum architecture of the quantum computer 100. For illustrative purposes, control lines 130-1 and 130-2 are depicted in FIG. 1 as separate lines for transmitting control signals 132 and receiving readout signals 134 but these can also be implemented on the same control lines 130.

Each qubit 112 has a tunable qubit frequency ωᵢ(t), where i indexes the qubit. Each coupler 114 has a tunable two-qubit coupling strength gᵢⱼ(t) describing the interaction between two adjacent qubits, where i and j index the adjacent qubits. The qubit frequencies and coupling strengths of the qubits 112 and couplers 114 can be controlled by the control system 120 using control signals 132. Tuning the qubit frequency of a respective qubit adjusts the energies of the states of the qubit. Tuning the two-qubit coupling strength of a respective coupler adjusts the coupling between two adjacent qubits interacting via the coupler. In some implementations described herein, the coupling strengths are tunable through zero gᵢⱼ=0, meaning the interactions between each adjacent qubit can be turned on or off as desired by control system 120, at least to sufficiently close approximation, i.e., within the limits of hardware accuracy. For example, control system 120 can isolate a quantum subsystem including two or more qubits by turning on their respective couplers and turning off the couplers of all other qubits. See the quantum subsystems 210 and 250 depicted in FIGS. 2A and 2B respectively for an example.

Each qubit 112 includes two computational states |0 [symbol] and |1 [symbol] and may also include one or more non-computational states |2 [symbol] , |3 [symbol] , etc. Transitions from computational states to a non-computational state are undesirable and referred to as leakage. Leakage can reduce the fidelity of a quantum computation being performed by the qubits 112. Amongst the possible unwanted transitions, transitions from a computational state to the non-computational state |2 [symbol] may be most likely to occur. For example, unwanted transitions can occur in the quantum system 110 due to nonzero coupling between computational state |11 [symbol] and non-computational states |02 [symbol] and |20 [symbol] imposed by the associated coupler. Other effects such as conditional (ZZ) phase accumulation can also occur due to the coupling between computational state |11 [symbol] and non-computational states |02 [symbol] and |20 [symbol] which can be undesirable when implementing certain quantum gates, e.g., iSWAP gates. Systems and methods of implementing two-qubit quantum gates that suppress unwanted transitions and allow for controllable ZZ phase are described in detail below.

FIG. 2A shows a schematic diagram of an example quantum circuit 220 that can execute a quantum processing algorithm. The quantum circuit 220 is realized by a quantum subsystem 210 of the quantum system 110 in FIG. 1. As mentioned above, to isolate the quantum subsystem 210, control system 120 may tune the coupling strengths of all couplers not associated with quantum subsystem 210 to zero. Control system 120 may implement quantum circuits using any number of qubits 112, ranging from two qubits to all qubits included in the quantum system 110. Control system 120 may also implement multiple quantum circuits in parallel using multiple quantum subsystems.

The quantum subsystem 210 in FIG. 2A includes five qubits 112-1, 112-2, 112-3, 112-4, and 112-5 interacting via four couplers 114-A, 114-B, 114-C, and 114-D to realize the quantum circuit 220. The qubits 112 and couplers 114 of the quantum subsystem 210 are manipulated and measured by control system 120 using appropriate control signals 132 and readout signals 134.

Particularly, control system 120 initializes 212 an initial state |ψᵢₙₜ [symbol] of the quantum subsystem 210, in this case all qubits in their respective ground state |ψᵢₙₜ [symbol] =|00000 [symbol] , and evolves 214 its state for a period of time to reach a final state |ψ_{fin} [symbol] . During the evolving, control system 120 implements a sequence of one-qubit 221 and two-qubit 222 quantum gates at each time step tₙ by applying various control signals 132 to the quantum subsystem 210. Generally, control system 120 implements the quantum circuit 220 for a period of time less than the coherence time of the qubits 112 to avoid nonunitary processes resulting from decoherence. The sequence of quantum gates corresponds to a sequence of n=1, 2, . . . , N unitary transformations |ψ_{fin} [symbol] =U_{N}U_{N-1} . . . U₁|ψᵢₙₜ [symbol] . In this case, each unitary transformation Uₙ is a two-qubit gate 222 or a combination of one-qubit gates 221. However, control system 120 may also perform multiple two-qubit 222 and one-qubit 221 gates simultaneously such that a unitary transformation Uₙ is a combination of one or more two-qubit gates 222 and one or more one-qubit gates 211. In some implementations, control system 120 may implement higher-order gates on the quantum subsystem 210, e.g., three-qubit quantum gates, four-qubit quantum gates, five-qubit quantum gates, and so on. At the end of the period of time, control system 120 performs a measurement 216 of the final state |ψ_{final} [symbol] of the quantum subsystem 210, e.g., by applying a measurement operator M|ψ_{final} [symbol] such as M=Z on the qubits 112, which can be read out by control system 120 using readout signals 134.

FIG. 2B shows a schematic diagram of implementing an example two-qubit quantum gate 222 on a quantum subsystem 250 using a pulse schedule 252. As outlined in Eq. (1) above, in a two-qubit excitation-conserving interaction, a two-qubit quantum gate 222 belongs to the Fermionic simulation (fSim) gate set U=fSim(θ, ϕ), with θ being the swap angle and ϕ being the conditional (ZZ) phase. The pulse schedule 252 techniques described herein can be used to set the control phases θ and ϕ to any desired value with low leakage and high fidelity. For example, control system 120 can realize a high fidelity iSWAP gate

$$U = fSim ( \frac{π}{2} , 0 )$$

or a high fidelity CZ gate U=fSim(0, π) using such pulse schedule 252 techniques.

Examples of low leakage can be about 10⁻⁷ or less, about 10⁻⁶ or less, about 10⁻⁵ or less, about 10⁻⁴ or less, about 10⁻³ or less, about 10⁻² or less.

Examples of high fidelity can be about 95% or more, about 99% or more, about 99.5% or more, about 99.9% or more, about 99.95% or more, about 99.99% or more.

The quantum subsystem 250 includes a first qubit 112-1 and a second qubit 112-2 interacting via a coupler 114. The first 112-1 and second 112-2 qubits have tunable qubit frequencies ω₁(t) and ω₂(t), respectively, which can be measured in gigahertz (GHz). In some implementations, the qubit frequencies are tunable within a range of about 5 GHz to 7 GHz.

In this case, the qubits 112-1 and 112-2 are described as coupled nonlinear quantum harmonic oscillators (QHOs), in particular, coupled quantum Duffing oscillators (QDOs). The first 112-1 and second 112-2 qubits have qubit anharmonicities η₁ and η₂, respectively, which characterize their nonlinear (i.e., anharmonic) behavior. The qubit anharmonicities can be measured in megahertz (MHz). In some implementations, the qubit anharmonicities can be in range of about 200 MHz to 300 MHz.

The coupler 114 has a tunable two-qubit coupling strength g(t)=g₁₂(t) that describes the interaction between the first 112-1 and second 112-2 qubits. The two-qubit coupling strength can be measured in MHz. In some implementations, the two-qubit coupling strength is tunable within a symmetric range of about −100 MHz to 100 MHz. In other implementations, the two-qubit coupling strength is tunable through an asymmetric range of about −25 MHz to 100 MHz, or an asymmetric range of about −100 MHz to 25 MHz. Any of these ranges can be suitable for the pulse schedule 252. Note, the two-qubit coupling strength describes the resultant interaction between the first 112-1 and second 112-2 qubits which may be a function of other parameters (e.g., a qubit-coupler detuning, a static qubit-qubit coupling, and/or a qubit-coupler coupling) depending on circuit element and/or hardware choices, e.g., topology of inductors and capacitors in a superconducting quantum computer, type and size of optical waveguides in an atomic quantum computer, type and size of microwave resonators in an NMR quantum computer, etc.

To implement the two-qubit quantum gate 222, control system 120 applies the pulse schedule 252 to the quantum subsystem 250, e.g., using control signals 132, while the quantum subsystem 250 is evolving. The pulse schedule 252 varies the qubit frequencies ω₁(t) and ω₂(t) and the coupling strength g(t) in a particular way such that the resulting unitary transformation U of the two-qubit interaction, after a predefined period of time t₀, defines the two-qubit gate 222. The maximum speed at which control system 120 can vary the parameters ω₁(t), ω₂(t) and g(t) is generally limited by the bandwidth of its control devices 122, which can be measured in GHz. In some implementations, such as a microwave control system 120, the bandwidth of the control system 120 can be about 0.5 GHz to 1 GHz.

In some implementations, the Hamiltonian (Ĥ) describing the two-qubit quantum subsystem 250 can be represented, at least approximately, by:

$$\hat{H} ( t ) = {\sum }_{i = 1}^{2} [ {ω}_{i} ( t ) {\hat{n}}_{i} + \frac{{η}_{i}}{2} {\hat{n}}_{i} ( {\hat{n}}_{i} - 1 ) ] + g ( t ) ( {\hat{a}}_{1} {\hat{a}}_{2}^{†} + {\hat{a}}_{1}^{†} {\hat{a}}_{2} ) , \qquad ( 2 )$$

where Planck's constant ℏ=1 is set to unity for convenience. The first term in Eq. (2) involving ωᵢ(t) and ηᵢ is the Duffing Hamiltonian for each qubit 112-1 and 112-2. The second term in Eq. (2) involving g(t) is the coupling Hamiltonian between the qubits 112. Here, \hat{n}ᵢ=âᵢ^{†}âᵢ is a respective excitation (e.g., photon) number operator of the first 112-1 or second 112-2 qubit in the basis of their respective states |0 [symbol] , |1 [symbol] , |2 [symbol] , |3 [symbol] , etc., while âᵢ^{†} and âᵢ are respective creation and annihilation operators of the first 112-1 or second 112-2 qubit. The creation and annihilation operators satisfy the commutation relations [âᵢ, âⱼ^{†}]=δᵢⱼ where δᵢⱼ is the Kronecker-delta and [âᵢ, âⱼ]=[âᵢ^{†}, âⱼ^{†}]=0. For example, the number operators act on a respective state as \hat{n}ᵢ|nᵢ [symbol] =nᵢ|nᵢ [symbol] , the creation operators act on a respective state as âᵢ|nᵢ [symbol] =\sqrt{nᵢ+1}|nᵢ+1 [symbol] , and the annihilation operators act on a respective state as âᵢ|nᵢ [symbol] =\sqrt{nᵢ}|nᵢ−1 [symbol] . Moreover, the Hamiltonian has the symmetry [\hat{N}, Ĥ]=0, where \hat{N}=\hat{n}₁+\hat{n}₂ is the total excitation number operator of the two qubits 112-1 and 112-2, meaning the two-qubit eigenstates of Ĥ conserve excitations.

In this case, the unitary transformation U defining the two-qubit gate 222 corresponds to the evolution of the state of quantum subsystem 250 after the predefined period of time U= [symbol] (t₀), where [symbol] (t)=−iĤ(t) [symbol] (t) follows from the Schrodinger equation. Control system 120 can estimate U by discretizing the pulse schedule 252 waveforms and performing a time-ordered integral of Ĥ(t) from 0 to t₀, e.g., by using a Dyson series on [symbol] (t)=1−∫₀^{t} Ĥ(t′) [symbol] (t′)dt′.

Control system 120 uses the computational states |00 [symbol] , |01 [symbol] , |10 [symbol] and |11 [symbol] of the quantum subsystem 250 to implement the two-qubit quantum gate 222. However, as seen in the coupling Hamiltonian of Eq. (2), there is nonzero coupling (a ZZ-interaction) between the computational state |11 [symbol] and the non-computational states |02 [symbol] and |20 [symbol] , corresponding to [symbol] 02|Ĥ(t)|11 [symbol] = [symbol] 20|Ĥ(t)|11 [symbol] =\sqrt{2}g(t). These are generally the dominate leakage channels as they induce a cycle between |11 [symbol] ↔|02 [symbol] or |11 [symbol] ↔|20 [symbol] . Such cycling also causes conditional (ZZ) phase ϕ accumulation which can be desirable (e.g., for CZ gates) or undesirable (e.g., for iSWAP gates) depending on the context. Control system 120 can mitigate the leakage into |02 [symbol] and |20 [symbol] while controlling ZZ phase accumulation by performing an appropriate pulse schedule 252.

To attack the problem, it is advantageous to redefine the Hamiltonian of Eq. (2) in terms of the qubit-qubit frequency detuning Δ(t)=(ω₁(t)−ω₂(t))/2 and the average of the two qubit frequencies Σ(t)=(ω₁(t)+ω₂(t))/2 such that:

$$\hat{H} ( t ) = Σ ( t ) \hat{N} + Δ ( t ) ( {\hat{n}}_{1} - {\hat{n}}_{2} ) + \frac{{η}_{1}}{2} {\hat{n}}_{1} ( {\hat{n}}_{1} - 1 ) + \frac{{η}_{2}}{2} {\hat{n}}_{2} ( {\hat{n}}_{2} - 1 ) + g ( t ) ( {\hat{a}}_{1} {\hat{a}}_{2}^{†} + {\hat{a}}_{1}^{†} {\hat{a}}_{2} ) . \qquad ( 3 )$$

Since \hat{N} is conserved, Σ(t) is a free parameter that does not significantly affect the implementation of the two-qubit quantum gate 222. Particularly, moving into the rotating frame of the qubits 112 using the unitary transformation [symbol] (t), where [symbol] (t)=−iΣ(t)\hat{N} [symbol] (t), the Hamiltonian in Eq. (2) is equivalent to:

$$\hat{H} ( t ) = Δ ( t ) ( {\hat{n}}_{1} - {\hat{n}}_{2} ) + \frac{{η}_{1}}{2} {\hat{n}}_{1} ( {\hat{n}}_{1} - 1 ) + \frac{{η}_{2}}{2} {\hat{n}}_{2} ( {\hat{n}}_{2} - 1 ) + g ( t ) ( {\hat{a}}_{1} {\hat{a}}_{2}^{†} + {\hat{a}}_{1}^{†} {\hat{a}}_{2} ) , \qquad ( 4 )$$

where [ [symbol] (t), Ĥ(t)]=0 is a symmetry. The average qubit frequency Σ(t) may be used by control system 120 to avoid coupled two-level system defects present in the frequency spectrum of either qubit 112-1 and 112-2, see for example, Yoni Shalibo, et al. “Lifetime and coherence of two-level defects in a Josephson junction,” Physical Review Letters 105.17 (2010): 177001.

In general, transitions to the other non-computational states |12 [symbol] , |21 [symbol] , |03 [symbol] , etc. are negligible due to having energy scales outside the bandwidth of the control system 120. Excitation conservation also suppresses such transitions. Hence, operating in the state basis |00 [symbol] , |01 [symbol] , |10 [symbol] , |11 [symbol] , |02 [symbol] , and |20 [symbol] , the Hamiltonian of Eq. (4) can be approximated in matrix form as:

$$\hat{H} ( t ) = [ \begin{matrix}0 & 0 & 0 & 0 & 0 & 0 \\ 0 & - Δ ( t ) & g ( t ) & 0 & 0 & 0 \\ 0 & g ( t ) & Δ ( t ) & 0 & 0 & 0 \\ 0 & 0 & 0 & 0 & \sqrt{2} g ( t ) & \sqrt{2} g ( t ) \\ 0 & 0 & 0 & \sqrt{2} g ( t ) & - 2 Δ ( t ) + {η}_{2} & 0 \\ 0 & 0 & 0 & \sqrt{2} g ( t ) & 0 & 2 Δ ( t ) + {η}_{1}\end{matrix} ] . \qquad ( 5 )$$

To implement the two-qubit quantum gate 222, control system 120 generally proceeds by idling the qubit frequencies at a constant (e.g., zero or non-zero) detuning Δ(t)=Δ₀ and zero coupling strength g(t)=0 for times t<0, such that the first 112-1 and second 112-2 qubits are decoupled from each other. Control system 120 then applies the pulse schedule 252 to vary these parameters Δ(t)=Δ₀+Δ₁(t) and g(t)≠0 over times 0<t<t₀ which couples the qubits 112-1 and 112-2 in a controlled, dynamical manner. The resulting unitary transformation U after the predefined period of time t₀ defines the two-qubit quantum gate 222.

To perform the pulse schedule 252, control system 120 can apply baseband pulses to the detuning Δ(t), the coupling strength g(t), or both. Control system 120 can also apply parametric pulses to the detuning Δ(t), the coupling strength g(t), or both. For example, control system 120 can apply a baseband pulse to Δ(t) and a parametric pulse to g(t), or vice versa. As another example, control system 120 can apply baseband pulses to both Δ(t) and g(t) and then modulate one or both of the baseband pulses with a respective parametric pulse, e.g., using amplitude, frequency, and/or phase modulation.

A baseband pulse is a lowpass signal and refers to a waveform having a frequency spectrum from (or near) zero to a cutoff frequency f_{B} such that its bandwidth is equal to the cutoff frequency f_{B}. Generally, the smaller the bandwidth, the more “DC” the baseband pulse is. For example, a rectangular pulse with a large pulse width (i.e., that has constant amplitude for a long period of time) has a small bandwidth. Other types of baseband pulses such as rectangular pulses with different roll-off factors, e.g., due to pulse shaping filters (e.g., sinc shaped, raised-cosine, and Gaussian filters), are also feasible.

A parametric pulse is a bandpass signal and refers to a waveform having a frequency spectrum from a lower (nonzero) cutoff frequency f_{L} to an upper cutoff frequency f_{U} such that its bandwidth is equal to the difference in the two cutoff frequencies Δf=f_{U}−f_{L}. A parametric pulse generally has a center frequency f_{C} that is a measure of a central frequency between the upper and lower cutoff frequencies. For example, the center frequency can be the arithmetic mean or the geometric mean of the lower cutoff frequency and the upper cutoff frequency. The center frequency often corresponds to a “drive” or “driving” frequency of a parametric pulse since its frequency spectrum can have a very large Q factor around this frequency Q=f_{C}/Δf. For example, a sinusoidal wave oscillates at its center (or drive) frequency and has a Q factor approaching Q→∞. Other types of oscillating waveforms can also be implemented as parametric pulses such as triangular waves, squares waves, sawtooth waves, among others.

As an example, to implement a CZ gate, control system 120 can choose a rectangular baseband pulse Δ₁(t)=(−Δ₀+η₂/2)rect

$$( \frac{t - {t}_{0} / 2}{{r}_{0}} )$$

which has a pulse width of t₀ and corresponding bandwidth of f_{B}=t₀⁻¹. This tunes qubit frequencies such that the |11 [symbol] and |02 [symbol] states are on resonance with each other Δ(t)=η₂/2 between 0<t<t₀. Control system 120 can tune either ω₁(t), ω₂(t), or both to bring |11 [symbol] and |02 [symbol] on resonance with each other. Control system 120 can simultaneously apply a rectangular baseband pulse to the coupler g(t)=g₀rect

$$( \frac{t - {t}_{0} / 2}{{r}_{0}} )$$

having the same pulse width t₀ and bandwidth f_{B}=t₀⁻¹, such that g(t)=g₀ between 0<t<t₀. This corresponds to a resonant Rabi cycle between |111 [symbol] ↔|02 [symbol] which has a conditional (ZZ) phase of ϕ=π when the predefined period of time is t₀=π/(\sqrt{2}|g₀|). In other words, the state |11 [symbol] →−|11 [symbol] returns to itself with a minus sign after a time of to. More generally, to implement the CZ gate, the predefined period of time can be t₀=(2m+1)/(\sqrt{2}|g₀|), where m is a positive integer, such that the Rabi cycle is performed multiple times before |11 [symbol] returns to itself. Note, control system 120 can perform an analogous procedure between the |11 [symbol] and |20 [symbol] states to implement the CZ gate. That is, control system 120 can choose a rectangular baseband pulse Δ₁(t)=(−Δ₀−η₁/2)rect

$$( \frac{t - {t}_{0} / 2}{{r}_{0}} )$$

that brings |11 [symbol] and |20 [symbol] on resonance with each other Δ(t)=−η₁/2 between 0<t<t₀ and apply the same baseband pulse to the coupler as described above.

As another example, to implement an iSWAP-like gate, control system 120 can choose a rectangular baseband pulse Δ₁(t)=−Δ₀rect

$$( \frac{t - {t}_{0} / 2}{{r}_{0}} )$$

which has a pulse width of t₀ and corresponding bandwidth of f_{B}=t₀⁻¹. This tunes qubit frequencies such that the |01 [symbol] and |10 [symbol] states are on resonance with each other Δ(t)=0 between 0<t<t₀. Control system 120 can tune either ω₁(t), ω₂(t), or both to bring |01 [symbol] and |10 [symbol] on resonance with each other. Control system 120 can simultaneously apply a rectangular baseband pulse to the coupler g(t)=g₀rect

$$( \frac{t - {t}_{0} / 2}{{r}_{0}} )$$

having the same pulse width t₀ and bandwidth f_{B}=t₀⁻¹, such that g(t)=g₀ between 0<t<t₀. This corresponds to a resonant Rabi cycle between |01 [symbol] ↔|10 [symbol] which has a swap angle of

$$θ = \frac{π}{2}$$

when the predefined period of time is t₀=π/(2|g₀|). In other words, the states swap with each other |01 [symbol] →−|10 [symbol] and |10 [symbol] →−|01 [symbol] after a time of to. More generally, to implement the iSWAP-like gate, the predefined period of time can be t₀=(2m+1)π/(2|g₀|), where m is a positive integer, such that the Rabi cycle is performed multiple times before completing the swap.

The iSWAP-like gate is not a “pure” iSWAP gate because the |11 [symbol] state is non-negligibly populated and performs Rabi cycles between |02 [symbol] and/or |20 [symbol] states to accumulate a non-negligible conditional (ZZ) phase ϕ≠0. This makes the iSWAP-like gate unsuitable for applications such as surface code error correction. To combat this, and realize a “pure” iSWAP gate, control system 120 can apply a parametric pulse g₁(t) that amplitude modulates the baseband pulse on the coupler:

$$g ( t ) = ( {g}_{0} + {g}_{1} ( t ) ) rect ( \frac{t - {t}_{0} / 2}{{t}_{0}} ) , \qquad ( 6 )$$

such that g(t)=g₀+g₁(t) between 0<t<t₀. The parametric pulse g₁(t)=g₁ cos (2πf_{C}t) generally has a center (or drive) frequency f_{C} higher than an average qubit anharmonicity f_{C}>(η₁+η₂)/2 to ensure the parametric pulse interacts predominately with the |11 [symbol] , |02 [symbol] , and |20 [symbol] subspace when the |01 [symbol] and |10 [symbol] subspace is on resonance Δ(t)=0. In other words, the driving frequency f_{C} is detuned from the |01 [symbol] and |10 [symbol] subspace but tuned to the |11 [symbol] , |02 [symbol] , and |20 [symbol] subspace. As explained below, tuning the center frequency past the qubit anharmonicity allows control system 120 to tune the ZZ phase through zero.

In a similar vein, the baseband pulses generally have bandwidths less than the average qubit anharmonicity f_{B}<(η₁+η₂)/2, or at least have negligible frequency content near the qubit anharmonicity, to ensure the baseband pulses do not unnecessarily excite transitions to the |02 [symbol] and |20 [symbol] states at the outset of (or during) the pulse schedule 252. In cases where the baseband pulses have non-negligible frequency content near the qubit anharmonicity, control system 120 may align a dip in the frequency spectrum of the baseband pulses around η₁ and/or η₂ to minimize deleterious effects. Such situations can be suitable when control system 120 drives the quantum subsystem 250 as fast as possible within control system 120's bandwidth, e.g., for gate lengths comparable to the qubit anharmonicity t₀⁻¹≈(η₁+η₂)/2.

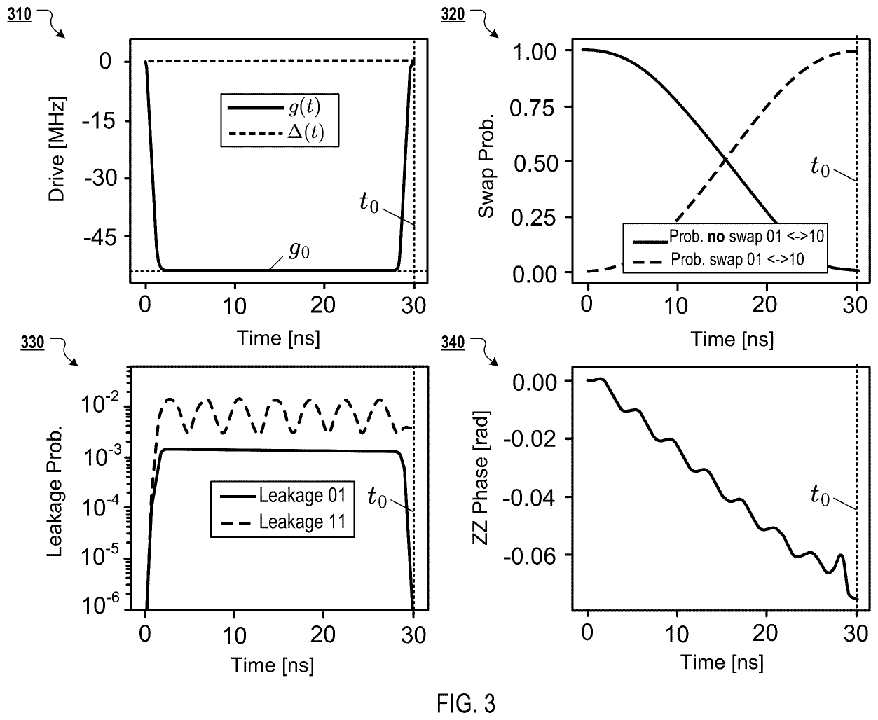

FIGS. 3, 4, 5, and 7 show example plots related to control system 120 parametrically driving the quantum subsystem 250 with various baseband amplitudes g₀, parametric drive amplitudes g₁, and parametric drive frequencies f_{C} to implement iSWAP-like gates and iSWAP gates. In these examples, the qubit anharmonicities of the first 112-1 and second 112-2 qubits are assumed identical for demonstrative purposes η₁=η₂=η≈260 MHz and the predefined period of time, corresponding to the gate length, is t₀≈30 nanoseconds (ns).

FIG. 3 shows plots of an example pulse schedule 310, swap probability 320, leakage probability 330, and conditional (ZZ) phase 340 of an iSWAP-like gate as a function of time.

As mentioned above and observed in plot 310, control system 120 brings the states |01 [symbol] and |10 [symbol] on resonance Δ(t)=0 by tuning the qubit frequencies of the qubits 112-1 and 112-2 with a rectangular baseband pulse. Control system 120 simultaneously applies a rectangular baseband pulse to the coupler g(t)=g₀≈−53 MHz to perform the swap |01 [symbol] ↔|10 [symbol] . As seen in plot 320, the probability of a swap is sin² θ≈1 at the predefined period of time t=t₀ and the leakage probability (plot 330) is also negligible at t=t₀. Here, “Leakage 01” and “Leakage 11” refers to the probability of qubits initialized in respective computational states |01 [symbol] and |11 [symbol] transitioning to non-computational states |02 [symbol] and/or |20 [symbol] . As mentioned above and observed in plot 330, leakage is dominated by |11 [symbol] transitions to |02 [symbol] and/or |20 [symbol] but this is still negligible (≈10^{-2.7}) and corresponds to a gate fidelity of ≈99.8%. However, as seen in plot 340, the accumulated conditional (ZZ) phase is non-negligible ϕ≈−0.08 at t=t₀ and renders the iSWAP-like gate unsuitable for applications such as surface code error correction.

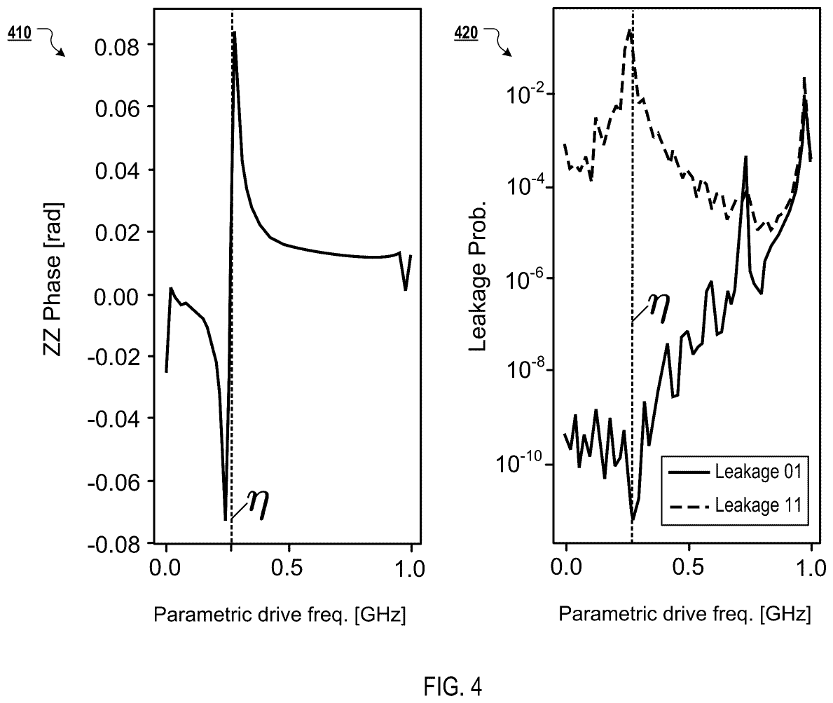

FIG. 4 shows plots of conditional (ZZ) phase 410 and leakage probability 420 at a time of t=t₀ for an example iSWAP-like gate as a function of parametric driving frequency f_{C}. Here, the baseband amplitude is g₀≈−53 MHz and the parametric amplitude is g₁≈49 MHz.

As seen in plot 410, the drive frequency passes through a resonance at the qubit anharmonicity f_{C}=η≈260 MHz such that the ZZ phase changes sign, i.e., passes through zero. Hence, control system 120 can choose a suitable drive frequency f_{C} and drive amplitude g₁ for the parametric pulse g₁(t)=g₁ cos (2πf_{C}t) to cancel the accumulated ZZ phase. Moreover, as seen in plot 420, the dominate Leakage 11 probability decays when passing through this resonance such that control system 120 can also choose the parametric drive frequency f_{C} and amplitude g₁ to mitigate leakage, therefore increasing fidelity.

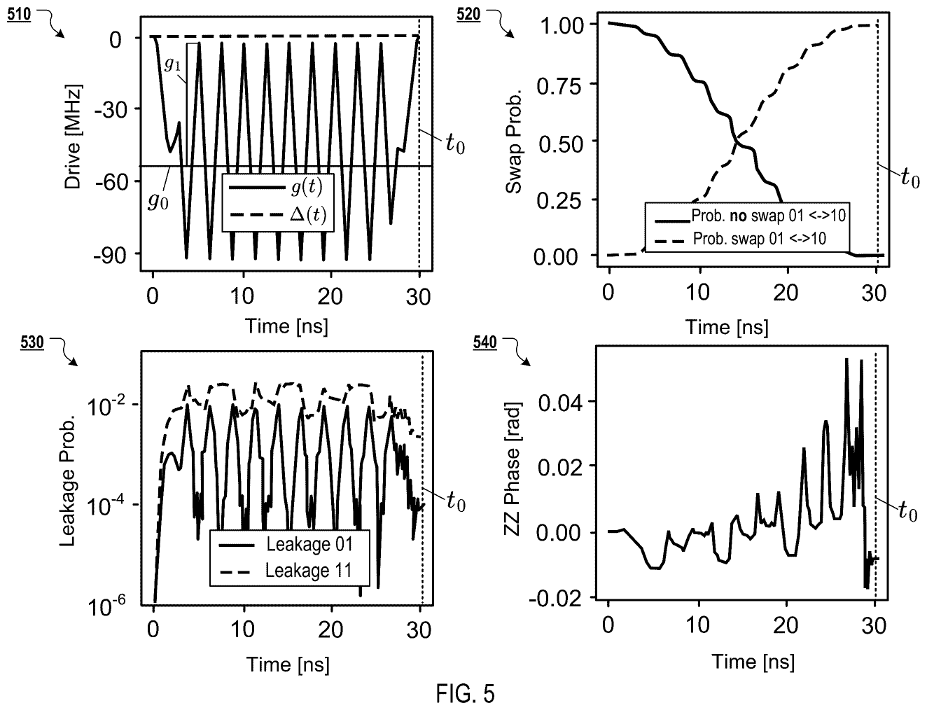

FIG. 5 shows plots of an example pulse schedule 510, swap probability 520, leakage probability 530, and conditional (ZZ) phase 540 of an iSWAP gate as a function of time.

As mentioned above and observed in plot 510, control system 120 brings the states |01 [symbol] and |10 [symbol] on resonance Δ(t)=0 by tuning the qubit frequencies of the qubits 112-1 and 112-2 with a rectangular baseband pulse. Control system 120 simultaneously applies a rectangular baseband pulse to the coupler that is amplitude modulated by a sinusoidal parametric pulse g(t)=g₀+g₁(t), where g₁(t)=g₁ cos (2πf_{C}t). In this case, the baseband amplitude is g₀≈−53 MHz, the parametric driving amplitude is g₁≈49 MHz, and the parametric driving frequency is f_{C}≈350 MHz. The driving frequency is higher than the qubit anharmonicity f_{C}>η but still within the bandwidth of the control system 120.

The baseband pulse g₀ performs the swap |01 [symbol] ↔|10 [symbol] while the parametric pulse g₁(t) manipulates the |11 [symbol] , |02 [symbol] , and |20 [symbol] states. Since the states |01 [symbol] and |10 [symbol] are detuned from f_{C}, the rapid fluctuations in g₁(t) average out such that the |01 [symbol] and |10 [symbol] subspace experiences a relatively constant coupling≈g₀. On the other hand, since the states |11 [symbol] , |02 [symbol] , and |20 [symbol] are closely tuned to f_{C}, the parametric pulse g₁(t) induces transitions between the |11 [symbol] , |02 [symbol] , and |20 [symbol] subspace which allows control system 120 to control the conditional (ZZ) phase.

As seen in plot 520, although the parametric drive causes “wiggles”, the probability of a swap is still sin² θ≈1 at the predefined period of time t=t₀. Moreover, as seen in plot 530, the dominate Leakage 11 probability at t=t₀ is still negligible (≈10^{-2.7}) and corresponds to a gate fidelity of ≈99.8%. Further still, as seen in plot 540, the accumulated ZZ phase is now negligibly small ϕ≈−0.01 at t=t₀. Hence, control system 120 achieves an iSWAP gate that may be suitable for applications such as surface code error correction.

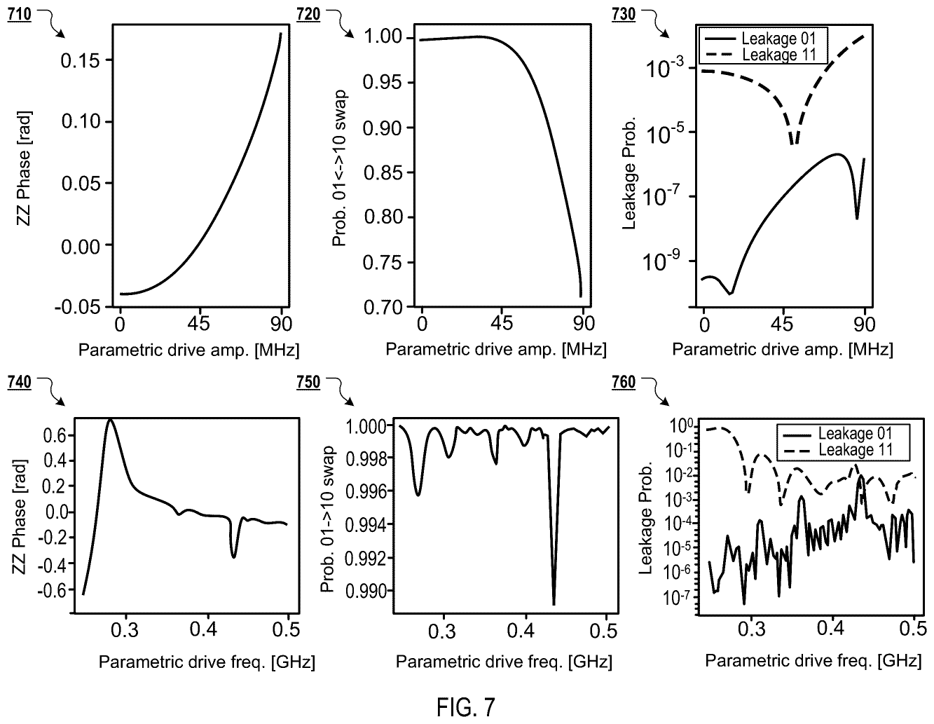

Note, the particular operating parameters discussed above, e.g., gate length, parametric drive frequency, parametric drive amplitude, baseband amplitude, etc., are merely examples to describe how to implement a parametric pulse schedule on the coupler. Such parametric pulse schedules may also include parametrically driving the first qubit, the second qubit, or both. Further techniques to improve these above metrics, e.g., swap probability, leakage, and/or ZZ phase, are discussed with respect to FIG. 7. Moreover, although the pulse schedule strategies are described with respect to iSWAP gates, such strategies are also suitable for the CZ gate and other fSim gates with arbitrary swap angle θ and conditional phase ϕ. For example, control system 120 may apply a parametric pulse to the coupler when implementing any of the fSim gates to control the conditional phase and reduce leakage probability.

The parametric pulse schedules described above can also be applied to higher-order quantum gates, e.g., three-qubit quantum gates, four-qubit quantum gates, five-qubit quantum gates, etc., to control various phases of such gates. For example, considering the quantum subsystem 210 depicted in FIG. 2A, control system 120 can implement a parametrically driven three-qubit quantum gate by applying baseband pulses to qubits 112-1, 112-2, and 112-3, to bring multiple three-qubit states on resonance. Control system 120 can simultaneously apply baseband pulses modulated by parametric pulses to couplers 114-A and 114-C to perform Rabi cycles between these states with controllable phases.

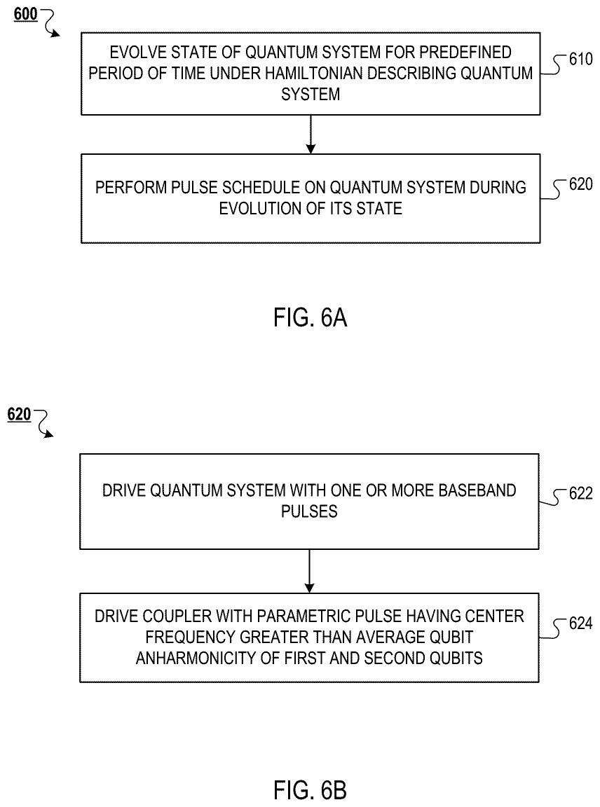

FIG. 6A is a flow chart of an example process 600 for implementing a two-qubit quantum gate on a quantum system using a pulse schedule. The quantum system includes a first qubit and a second qubit interacting via a coupler. For convenience, the processes 600 will be described as being performed by a control system of a quantum computer. For example, the control system 120 of the quantum computer 100 of FIG. 1, appropriately programmed in accordance with this specification, can perform the process 600.

Control system evolves a state of the quantum system for a predefined of time under a Hamiltonian describing the quantum system (610).

Control system performs the pulse schedule on the quantum system during evolution of its state (620).

FIG. 6B is a flow chart of an example process 620 for implementing the pulse schedule.

Control system drives the quantum system with one or more baseband pulses (622). In some implementations, the one or more baseband pulses have bandwidths less than an average qubit anharmonicity of the first and second qubits. For example, the one or more baseband pulses can be rectangular pulses. The one or more rectangular pulses can have pulse widths equal to the predefined period of time.

Control system drives the coupler with a parametric pulse having a center frequency greater than the average qubit anharmonicity of the first and second qubits (624). In some implementations, the parametric pulse is a sinusoidal wave oscillating at the center frequency.

In some implementations, control system drives at least one of the first or second qubits with a first baseband pulse to tune respective qubit frequencies of the first and second qubits. Tuning the qubit frequencies can include control system bringing a first state of the first and second qubits on resonance with a second state of the first and second qubits. For example, the first and second states can be computational states such as the |01 [symbol] and |10 [symbol] states. As another example, the first state can be a computational state such as the |11 [symbol] state and the second state can be a non-computational state such as the |02 [symbol] or |20 [symbol] states.

In some implementations, control system drives the coupler with a second baseband pulse to cycle between the first and second states. The second baseband pulse can be amplitude modulated by the parametric pulse.

FIG. 7 shows plots of conditional (ZZ) phase 710 and 740, swap probability 720 and 750, and leakage probability 730 and 760 of an iSWAP-like gate as functions of parametric driving amplitude g₁ and parametric driving frequency f_{d}, respectively. All plots 710-760 are evaluated at a time of t=t₀.

Referring first to plots 710, 720, and 730 which are functions of the drive amplitude g₁ at a fixed drive frequency of f_{C}≈350 MHz. It can be seen that the metrics, i.e., the ZZ phase, the swap probability, and the leakage probability, can be sensitive to the drive amplitude and there is generally an optimal drive amplitude that optimizes one or more of these metrics, or at least optimizes a weighted combination of these metrics. For example, the ZZ phase is ≈0, the swap probability is ≈1, and the leakage probability is ≈10⁻⁵, for a drive amplitude of g₁≈49 GHz. Hence, such a parameterization may implement a high fidelity iSWAP gate of ≈99.99%.

Referring now to plots 740, 750, and 760 which are functions of the drive frequency f_{C}>η for a fixed drive amplitude g₁≈49 MHz. It can be seen that there may be other parameterizations that are also suitable. For example, a drive frequency of f_{C}≈380 MHz has a corresponding ZZ phase of ≈0, a swap probability of ≈1, and a leakage of ≈10⁻³. Hence, control system 120 can probe the parameter space to determine the parameterization that optimizes a desired combination of these metrics.

For example, as a general strategy, control system 120 can first implement an iSWAP-like gate for a particular baseband pulse g₀ and predefined period of time to. Control system 120 can then add a modulating parametric pulse g₁(t)=g₁ cos (2πf_{C}t) with f_{C}>η to control the ZZ phase. Control system 120 can then vary the parametric drive amplitude g₁ and frequency f_{C} until a desired set of metrics are obtained for a high fidelity iSWAP gate, e.g., a swap probability of 0.99 or more, a ZZ phase between −0.02 rads to 0.02 rads, and a leakage of 10⁻² or less. That being said, control system 120 can perform further refinement by also varying the baseband amplitude g₀ for a particular predefined period of time to, or varying the period of time t₀ in conjunction with the baseband amplitude. Control system 120 can use various techniques, e.g., brute force, gradient descent, etc. to perform such a task and find the desired parametrization. This can also allow control system 120 to implement even faster iSWAP gates, CZ gates, and other fSim gates, e.g., by fixing the predefined period of time t₀ to a short gate length and then determining the parameters, g₀, g₁, and f_{C} that provide the desired values for the abovementioned metrics.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g., photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for implementing a two-qubit quantum gate on a quantum system comprising a first qubit and a second qubit interacting via a coupler, the method comprising:
evolving a state of the quantum system for a predefined period of time under a Hamiltonian describing the quantum system; and
performing a pulse schedule on the quantum system during evolution of its state, the pulse schedule comprising:
driving the quantum system with one or more baseband pulses; and
driving the coupler with a parametric pulse having a center frequency greater than an average qubit anharmonicity of the first and second qubits.

2. The method of claim 1, wherein the one or more baseband pulses have bandwidths less than the average qubit anharmonicity of the first and second qubits.

3. The method of claim 1, wherein the one or more baseband pulses are rectangular pulses.

4. The method of claim 3, wherein the one or more rectangular pulses have pulse widths equal to the predefined period of time.

5. The method of claim 1, wherein the parametric pulse is a sinusoidal wave oscillating at the center frequency.

6. The method of claim 1, wherein driving the quantum system with the one or more baseband pulses comprises:
driving at least one of the first or second qubits with a first baseband pulse to bring a first state of the first and second qubits on resonance with a second state of the first and second qubits.

7. The method of claim 6, wherein the first and second states are computational states.

8. The method of claim 6, wherein the first state is a computational state and the second state is a non-computational state.

9. The method of claim 6, wherein driving the quantum system with the one or more baseband pulses further comprises:
driving the coupler with a second baseband pulse to cycle between the first and second states.

10. The method of claim 9, wherein the second baseband pulse is amplitude modulated by the parametric pulse.

11. The method of claim 1, wherein the two-qubit quantum gate is a Fermionic simulation (fSim) gate.

12. The method of claim 11, wherein the fSim gate is an iSWAP gate or a CZ gate.

13. The method of claim 1, wherein the Hamiltonian (H) describing the quantum system is represented, at least approximately, by:
$$\hat{H} ( t ) = {\sum }_{i = 1}^{2} [ {ω}_{i} ( t ) {\hat{n}}_{i} + \frac{{η}_{i}}{2} {\hat{n}}_{i} ( {\hat{n}}_{i} - 1 ) ] + g ( t ) ( {\hat{a}}_{1} {\hat{a}}_{2}^{†} + {\hat{a}}_{1}^{†} {\hat{a}}_{2} ) ,$$
wherein \hat{n}ᵢ=âᵢ^{†}âᵢ is a respective excitation number operator of the first or second qubit, âᵢ^{†} and âᵢ are respective creation and annihilation operators of the first or second qubit, ωᵢ(t) is a respective qubit frequency of the first or second qubit, ηᵢ is a respective qubit anharmonicity of the first or second qubit, and g(t) is a two-qubit coupling strength of the coupler describing the interaction between the first and second qubits.

14. The method of claim 1, wherein the first and second qubits are superconducting qubits.

15. The method of claim 14, wherein the first and second superconducting qubits are transmon qubits.

16. The method of claim 1, wherein the average qubit anharmonicity is in a range from 200 megahertz (MHz) to 300 MHz.

17. The method of claim 1, wherein the center frequency is in a range from 250 MHz to 500 MHz.

18. The method of claim 1, wherein the predefined period of time is 50 nanoseconds (ns) or less.

19. An apparatus, comprising:
a quantum system comprising a first qubit and a second qubit interacting via a coupler; and
a control system comprising:
one or more control devices; and
one or more control lines coupled to the one or more control devices and the quantum system,
wherein the control system is configured to:
evolve a state of the quantum system for a predefined period of time under a Hamiltonian describing the quantum system; and
perform a pulse schedule on the quantum system during evolution of its state, the pulse schedule comprising:
driving the quantum system with one or more baseband pulses; and
driving the coupler with a parametric pulse having a center frequency greater than an average qubit anharmonicity of the first and second qubits.

20. The apparatus of claim 19, wherein the first and second qubits are superconducting qubits.
